(19) United States
(12) Patent Application Publication
(10) Pub. No.: US 2008/0163377 A1
(43) Pub. Date: Jul. 3, 2008

(54) Apparatus and method for transferring content rights by multimedia message in a mobile communication system

(75) Inventors: Woo-Suk Lee, Suwon-si (KR); Han-Seung Jung, Suwon-si (KR); Seung-Eun Kwon, Seoul (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/006,345

(22) Filed: Jan. 2, 2008

(30) Foreign Application Priority Data
Jan. 2, 2007 (KR) 2007-0000220

(51) Int. Cl. G06F 21/00

(52) U.S. Cl. 726/26

(57) ABSTRACT

An apparatus and method for transferring content rights by a multimedia message in a mobile communication system are provided, in which a DRM server transmits a right object associated with contents to an MS, upon request of the MS, a transmitting MS generates, upon generation of an event triggering a right object transfer, the right object with content rights to be transferred and a storage right object with remaining content rights, stores the storage right object, and transmits a message including the right object to a receiving MS, and the receiving MS receives the right object by the message from the transmitting MS and stores the right object.

### CROSS-REFERENCE TO RELATED APPLICATION(S) AND CLAIM OF PRIORITY

This application claims the benefit under 35 U.S.C. §119(a) of a Korean Patent Application filed in the Korean Intellectual Property Office on Jan. 2, 2007 and assigned Serial No. 2007-0000220, the entire disclosure of which is hereby incorporated by reference.

### TECHNICAL FIELD OF THE INVENTION

The present invention generally relates to an apparatus and method for transferring content rights by a multimedia message in a mobile communication system. More particularly, the present invention relates to an apparatus and method for devolving the whole or part of content rights from a Mobile Station (MS) to another mobile station by a multimedia message in a mobile communication system.

### BACKGROUND OF THE INVENTION

Digital Rights Management (DRM) is a recent active study area. DRM-based commercial services have been deployed or are being deployed. DRM is a technological concept for protecting digital contents from unauthorized duplication and distribution.

Efforts have been expended to protect digital contents, but mainly from unauthorized access. For example, access to digital contents is allowed only to users that pay for the access. However, the digital contents allows for easy reuse, processing, duplication, and distribution due to the nature of digital data. Therefore, even users that do not pay for their access can use the digital contents by unauthorized duplication or distribution.

To avert this problem, DRM regulates that digital contents are encrypted prior to distribution and requires a license called a Right Object (RO) for use of the encrypted digital contents.

The RO includes restriction information such as information about an allowed number or duration of contents use or an allowed number of contents duplications, to thereby impose some restriction on contents reuse or duplication. That is, DRM effectively protects digital contents.

Meanwhile, contents received at a mobile station are freely transferable to other mobile stations or forward-locked to prevent free transfer to other mobile stations. The former type is subject to free duplication and distribution to other mobile stations. The mobile station can transmit contents by a multimedia message to another mobile station. As compared to contents, only a DRM server transmits an RO to a mobile station, prohibiting transmission and reception of the RO between mobile stations, for security of the RO.

Contents are made transferable between mobile stations for the purpose of propagation of the contents. Thus, if a mobile station receives contents from another mobile station by a multimedia message, it should inconveniently access the DRM server and receive an RO to use the received contents.

Moreover, because only contents are transferable between mobile stations, the conventional technology makes it impossible for a mobile station to transfer part of an allowed number of content reuses to another mobile station by its RO.

### SUMMARY OF THE INVENTION

To address the above-discussed deficiencies of the prior art, it is a primary aspect of exemplary embodiments of the present invention to address at least the problems and and or disadvantages and to provide at least the advantages described below. Accordingly, an aspect of exemplary embodiments of the present invention is to provide an apparatus and method for transferring content rights by a multimedia message in a mobile communication system.

Another aspect of exemplary embodiments of the present invention is to provide an apparatus and method for transferring the whole or part of content rights by a multimedia message from one mobile station to another mobile station in a mobile communication system.

A further aspect of exemplary embodiments of the present invention is to provide an apparatus and method for transferring content rights, which can track an RO transfer and propagation path by transmitting an RO including fingerprint information.

In accordance with an aspect of exemplary embodiments of the present invention, there is provided a mobile communication system for transferring content rights, in which a DRM server transmits an RO associated with contents to a mobile station, upon request of the mobile station, a transmitting mobile station generates, upon generation of an event triggering an RO transfer, an outgoing RO with content rights to be transferred and a storage RO with remaining content rights, stores the storage RO, and transmits a message including the outgoing RO to a receiving mobile station, and the receiving mobile station receives the outgoing RO by the message from the transmitting mobile station and stores the outgoing RO.

In accordance with another aspect of exemplary embodiments of the present invention, there is provided a mobile station for transferring content rights, in which a memory stores ROs, a transmitter and receiver transmits and receives a message including an RO, an RO manager generates an outgoing RO with content rights to be transferred and a storage RO with remaining content rights, upon generation of an event triggering an RO transfer, and controls an existing RO to be updated with the storage RO in the memory, and a message processor generates a message including an RO and controls the message to be transmitted.

In accordance with a further aspect of exemplary embodiments of the present invention, there is provided a method for transferring content rights in a mobile station, in which content rights to be transferred are received and a count of the content rights is checked, upon generation of an event triggering an RO transfer, an outgoing RO is generated with the content rights to be transferred, a storage RO is generated with remaining content rights and stored to update an existing RO, and a message including the outgoing RO is generated and transmitted.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram of a mobile communication system for transferring an RO according to an exemplary embodiment of the present invention;

FIG. 2 is a block diagram of a mobile station for transmitting and receiving an RO and transferring content rights according to an exemplary embodiment of the present invention;

FIG. 3 is a flowchart of an operation for transferring the whole or part of an RO to another mobile station by a multimedia message in the mobile station according to an exemplary embodiment of the present invention; and

FIG. 4 is a flowchart of an operation for receiving the whole or part of an RO from another mobile station by a multimedia message in the mobile station according to an exemplary embodiment of the present invention.

Throughout the drawings, the same drawing reference numerals will be understood to refer to the same elements, features and structures.

### DETAILED DESCRIPTION OF THE INVENTION

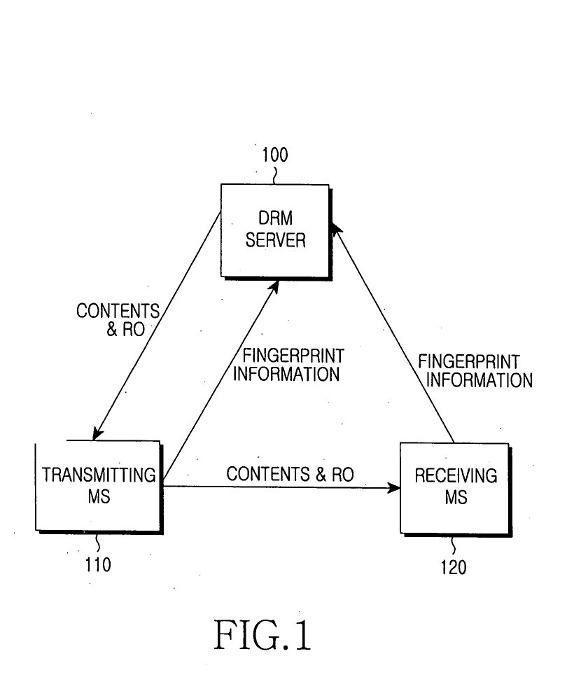

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The present invention is intended to provide an apparatus and method for transferring the whole or part of content rights by a multimedia message from one mobile station to another mobile station in a mobile communication system. The present invention also provides an apparatus and method for tracking the transfer and propagation path of an RO transmitted in a multimedia message by including fingerprint information in transmitted contents.

FIG. 1 is a block diagram of a mobile communication system for transferring an RO according to an exemplary embodiment of the present invention.

Referring to FIG. 1, the mobile communication system, in which mobile stations can transfer an RO wholly or partially to other mobile stations, includes a DRM server 100, a transmitting mobile station (MS) 110, and a receiving mobile station (MS) 120.

Upon a request from the transmitting MS 110, the DRM server 100 transmits contents and an RO to the transmitting MS 110 by the Wireless Application Protocol (WAP) or the Multimedia Messaging System (MMS). To track the transfer and propagation path of the RO, the DRM server 100 includes fingerprint information specific to the RO in the RO. In general, the DRM server 100 transmits the contents by Open Mobile Alliance (OMA) download and the RO by WAP Push.

Upon receipt of fingerprint information indicating transmission and reception of the RO from the mobile stations 110 and 120, the DRM server 100 stores the fingerprint information by which to track the transfer and propagation path of the RO.

RO transfer and propagation paths that can be tracked in the DRM server 100 can be important materials for service providers to develop contents providing schemes.

The transmitting MS 110 receives the contents and the RO from the DRM server 100, and upon generation of a right transfer event, re-generates ROs for the whole or partial transfer of the RO. These ROs include a storage RO to be stored in the transmitting MS 110 and an outgoing RO to be transmitted to the receiving MS 120.

The transmitting MS 110 transmits the contents and the outgoing RO to the receiving MS 120 by a multimedia message. When confirming that the contents and the outgoing RO have been successfully transmitted, the transmitting MS 110 stores only one RO (i.e., the storage RO), discarding the outgoing RO.

After the transmission, the transmitting MS 110 transmits fingerprint information included in the transmitted RO to the DRM server 100 by the WAP or the Short Message Service (SMS).

Upon receipt of the contents and the outgoing RO from the transmitting MS 110, the receiving MS 120 stores them without redundancy. That is, the receiving MS 120 deletes the same attached outgoing RO from a message box, if any.

The receiving MS 120 transmits the fingerprint information included in the received outgoing RO to the DRM server 100 usually by the WAP or the SMS.

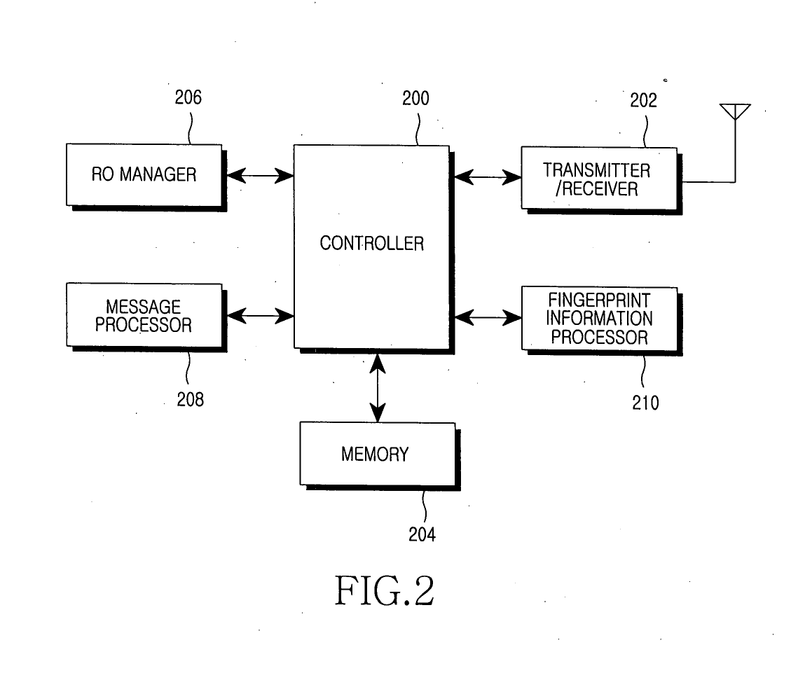

FIG. 2 is a block diagram of an MS for transmitting and receiving an RO and transferring content rights according to an exemplary embodiment of the present invention. This MS can be any of a cellular phone, a Personal Communication System (PCS), a Personal Data Assistant (PDA), and an International Mobile Communication 2000 (IMT2000) phone.

Referring to FIG. 2, the MS includes a controller 200, a transmitter and receiver 202, a memory 204, an RO manager 206, a message processor 208, and a fingerprint information processor 210.

For signal reception, the transmitter and receiver 202 downconverts a Radio Frequency (RF) signal received through an antenna to a baseband signals and processes the baseband signal by dispreading and channel decoding. For signal transmission, the transmitter and receiver 202 channel-encodes and spreads data, upconverts the spread data to an RF signal, and transmits the RF signal through the antenna. According to the present invention, the transmitter and receiver 202 transmits and receives a message with contents and an RO and transmits fingerprint information included in the RO to a DRM server.

The memory 204 stores programs for controlling the overall operation of the MS, application programs, and data to be kept (e.g., phone numbers, SMS messages, compressed image files, moving pictures, etc.). The memory 204 stores the received contents and RO according to the present invention.

Upon generation of a whole or partial RO transfer event, the RO manager 206 receives an RO with as many content rights as to be transferred, generates an outgoing RO including the content rights to be transferred and a storage RO with the remaining content rights, and controls the existing stored RO to be updated in the memory 204. When the RO is wholly transferred, the RO manager 206 does not generate the storage RO and deletes the transferred RO from the memory 204.

When the outgoing RO is successfully transmitted, the RO manager 206 controls the transferred RO not to be redundantly stored in the MS. That is, the RO manager 206 prevents additional storage of the outgoing RO in an outgoing message box.

Upon receipt of an outgoing RO from another MS, the RO manager 206 stores it in the memory 204. In this case, the RO manager 206 controls redundant storage of the received outgoing RO in the MS (e.g., an incoming message box).

When contents rights are transferred, the message processor 208 generates a multimedia message including contents and the outgoing RO received from the RO manager 206 and controls the multimedia message to be transmitted to a receiving MS through the transmitter and receiver 202.

The message processor 208 determines whether a received message from another MS is a multimedia message including contents and an RO. When the RO is transferred, the message processor 208 notifies the RO manager 206 and the fingerprint information processor 210 of the reception of the multimedia message.

When content rights are transferred to or from another MS, the fingerprint information processor 210 transmits fingerprint information included in an RO to the DRM server.

The controller 200 controls the RO manager 206, the message processor 208, and the fingerprint information processor 210. That is, the controller 200 can incorporate the functionalities of the RO manager 206, the message processor 208, and the fingerprint information processor 210. While the RO manager 206, the message processor 208, and the fingerprint information processor 210 are separately configured in FIG. 2, they can be wholly or partially integrated into the controller 200 in real implementation.

A method for transferring content rights by a multimedia message in the thus-configured mobile communication system will be described below.

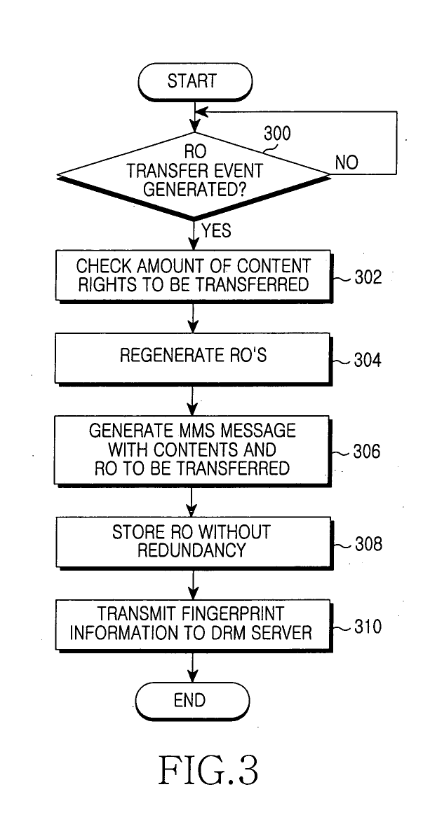

FIG. 3 is a flowchart of an operation for transferring the whole or part of an RO to another MS by a multimedia message in the MS according to an exemplary embodiment of the present invention.

Referring to FIG. 3, upon generation of an event triggering transfer of content rights in step 300, the MS checks the allowed number of reuses of an RO being the content rights and receives as many content rights as to be transferred in step 302. In step 304, the MS generates an outgoing RO with the content rights to be transferred and a storage RO with the remaining content rights, and updates the stored RO with the storage RO. If the RO is wholly transferred, the MS does not generate the storage RO and deletes the transferred RO from the memory.

In step 306, the MS generates a multimedia message with contents and the outgoing RO and transmits the multimedia message.

When completing normal transmission of the multimedia message, the MS makes sure that the transferred RO is not stored with redundancy in step 308 and transmits fingerprint information included in the RO to the DRM server, notifying the RO transfer in step 310.

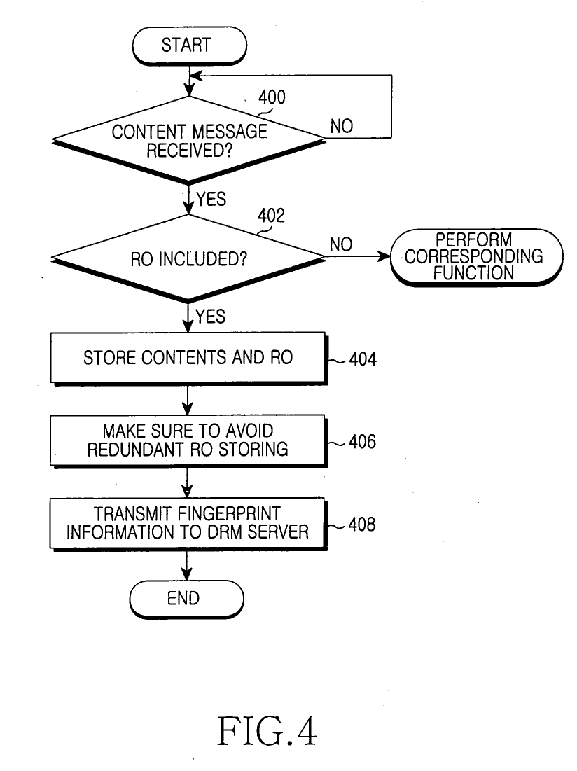

FIG. 4 is a flowchart of an operation for receiving the whole or part of an RO from another MS by a multimedia message in the MS according to an exemplary embodiment of the present invention.

Referring to FIG. 4, upon receipt of a message including contents from another MS in step 400, the MS determines whether the message further includes an RO in step 402. In the absence of the RO, the MS operates in a conventional manner,

In the presence of the RO, the MS stores the contents and the RO in step 404 and makes sure that the RO is not redundantly stored in a message box by checking the message box in step 406. In step 408, the MS transmits fingerprint information included in the RO to the DRM server, notifying that the RO has been transferred to the MS.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains. As is apparent from the above description, the present invention provides an apparatus and method for transferring content rights wholly or partially by a multimedia message from one MS to another MS in a mobile communication system. Therefore, there is no need for accessing a DRM server to receive an RO, when receiving contents from another MS, and information about the transfer and propagation path of the RO can be provided to a service provider.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A mobile communication system for transferring content rights, the system comprising:
a digital rights management (DRM) server for transmitting a right object (RO) associated with contents to a receiving mobile station (MS), upon a request of the receiving mobile station;
a transmitting mobile station for, upon generation of an event triggering an right object transfer, generating the right object for outgoing content rights to be transferred and a storage right object for remaining content rights, storing the storage right object, and transmitting a message including the right object to the receiving mobile station; and
the receiving mobile station for receiving the right object by the message from the transmitting mobile station and storing the right object.

2. The mobile communication system of claim 1, wherein the DRM server includes fingerprint information specific to the right object in the right object.

3. The mobile communication system of claim 2, wherein if the DRM server receives the fingerprint information from the transmitting mobile station and the receiving mobile station during the right object transfer, the DRM server stores the fingerprint information along with information about the transmitting mobile station and the receiving mobile station.

4. The mobile communication system of claim 1, wherein upon successful completion of the message transmission, the transmitting mobile station stores only the storage right object.

5. The mobile communication system of claim 1, wherein the transmitting mobile station transmits the message including the right object to the receiving mobile station by a multimedia message system (MMS).

6. The mobile communication system of claim 2, wherein the transmitting mobile station transmits the fingerprint information included in the right object to the DRM server, after the message transmission.

7. The mobile communication system of claim 6, wherein the transmitting mobile station transmits the fingerprint information to the DRM server by one of a wireless application protocol and a short message service.

8. The mobile communication system of claim 1, wherein upon receipt of the message including the right object, the receiving mobile station stores the-received right object without redundancy.

9. The mobile communication system of claim 2, wherein the receiving mobile station transmits the fingerprint information included in the right object to the DRM server, after the message reception.

10. The mobile communication system of claim 9, wherein the receiving mobile station transmits the fingerprint information to the DRM server by one of a wireless application protocol and a short message service.

11. A mobile station (MS) for transferring content rights, the mobile station comprising:
a memory for storing Right Objects (ROs);
a transmitter and receiver for transmitting and receiving a message including a right object;
a right object manager for, upon generation of an event triggering a right object transfer, generating the right object for outgoing content rights to be transferred and a storage right object for remaining content rights, and controlling updating the right object with the storage right object in the memory; and
a message processor for generating a message including the right object and controlling the message to be transmitted.

12. The mobile station of claim 11, wherein the right object manager stores only the storage right object, when the message including the right object is transmitted.

13. The mobile station of claim 11, wherein the right object includes fingerprint information specific to the right object.

14. The mobile station of claim 11, wherein upon receipt of the message including the right object, the right object manager stores the received right object without redundancy.

15. The mobile station of claim 11, wherein when the right object is wholly transferred, the right object manager controls the transferred right object to be deleted from the memory, without generating the storage right object.

16. The mobile station of claim 11, wherein the transmitter and the receiver transmit the message by a multimedia messaging system.

17. The mobile station of claim 13, further comprising a fingerprint information processor for, when the right object is transferred or received, transmitting fingerprint information included in the right object to a digital rights management (DRM) server.

18. The mobile station of claim 17, wherein the fingerprint information is transmitted to the DRM server by one of a wireless application protocol and a short message service.

19. A method for transferring content rights in mobile station (MS), the method comprising:
receiving content rights to be transferred and checking a count of the content rights, upon generation of an event triggering a right object (RO) transfer;
generating a right object for outgoing content rights to be transferred;
generating a storage right object for remaining content rights and storing the storage right object to update the right object;
generating a message including the right object; and
transmitting the message.

20. The method of claim 19, further comprising making sure that only the storage right object is stored, after the message transmission.

21. The method of claim 19, wherein the right object includes fingerprint information specific to the right object.

22. The method of claim 19, wherein the storage right object generation and storing comprises deleting the right object after it is transferred without generating the storage right object.

23. The method of claim 19, wherein the message transmission comprises transmitting the message by a multimedia messaging system.

24. The method of claim 21, further comprising transmitting the fingerprint information included in the right object to a digital rights management (DRM) server, after the message transmission.

25. The method of claim 24, wherein the fingerprint information transmission comprises transmitting the fingerprint information to the DRM server by one of a wireless application protocol and a short message service.

26. The method of claim 21, further comprising transmitting the fingerprint information included in the right object to the DRM server by a mobile station that receives the message.

27. A Computer-readable recording medium having recorded thereon a program for transferring content rights in mobile station (MS), comprising;
a first code segment for receiving content rights to be transferred and checking a count of the content rights, upon generation of an event triggering a right object (RO) transfer;
a second code segment for generating a right object for outgoing content rights to be transferred;
a third code segment for generating a storage right object for remaining content rights and storing the storage right object to update the right object;
a fourth code segment for generating a message including the right object; and
a fifth code segment for transmitting the message.
